(19) United States
(12) Patent Application Publication
(10) Pub. No.: US 2003/0106856 A1
(43) Pub. Date: Jun. 12, 2003

(54) Process and plant for the efficiency solubility of gas and sludge mixing

(76) Inventor: Hong-Bok Choe, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/275,777

(22) PCT Filed: May 8, 2001
(86) PCT No.: PCT/KR01/00743

(30) Foreign Application Priority Data
May 8, 2000 (KR) 2000/24347

(51) Int. Cl. C02F 1/68

(52) U.S. Cl. 210/750; 210/219; 210/208

(57) ABSTRACT

Disclosed is a wastewater treatment plant. The wastewater treatment plant comprises an aeration tank for storing wastewater; a reaction tank disposed inside the aeration tank, the wastewater being purified while circulating inside the reaction tank and being supplied with oxygen; an air intake tube for introducing air into the reaction tank; a dispersion member for dispersing the air introduced through the air intake tube to the wastewater to generate bubbles; and a blade assembly disposed inside the reaction tank for having the bubbles dispersed by the dispersion member come into collision with each other, prolonging a staying time of the bubbles to increase the dissolved oxygen, and directing the bubbles in a predetermined direction to lead the wastewater to agitate.

### TECHNICAL FIELD

The present invention relates to a wastewater treatment process and plant, and more particularly, to a wastewater treatment process and plant that can improve the wastewater treatment efficiency by effectively supplying oxygen to the wastewater and agitating the wastewater.

### BACKGROUND ART

Generally, a wastewater treatment process is performed to convert contaminated materials contained in water into stabilized materials through a microorganism treatment or a chemical oxidation-reduction reaction. Although a variety of technologies for stabilizing the polluted materials have been proposed, a biological treatment process, which is not costly, has been widely used.

However, since the treatment rate of such a biological treatment process depends on the natural decomposition rate of organic matter by microorganism, the treatment rate is too low. In addition, the treatment rate further depends on how effectively free oxygen or bonding oxygen, and organic matter which is a carbon source are supplied and how effectively the agitation for mixing microorganism and organic matter or nutritious substance is effectively realized.

Such a biological treatment process is classified into an aerobic treatment process and an anaerobic treatment process. The former is used for lightly contaminated wastewater, and the latter is used for highly contaminated wastewater.

The reason why the latter is used for the highly contaminated wastewater is that the highly contaminated wastewater cannot maintains the sufficient dissolved oxygen.

In addition, an aeration process, a pressure dissolved oxygen process and the like can be used to treat the wastewater. However, these processes are costly and time-consuming.

### DISCLOSURE OF INVENTION

Therefore, there is a need for a wastewater treatment plant that can increase the dissolved oxygen with less expense while effectively realizing the agitation of the wastewater.

To meet the above need, the present invention provides a wastewater treatment plant comprising an aeration tank for storing wastewater; a reaction tank disposed inside the aeration tank, the wastewater being purified while circulating inside the reaction tank and being supplied with oxygen; an air intake tube for introducing air into the reaction tank; a dispersion member for dispersing the air introduced through the air intake tube to the wastewater to generate bubbles; and a blade assembly disposed inside the reaction tank for having the bubbles dispersed by the dispersion member come into collision with each other, prolonging a staying time of the bubbles to increase the dissolved oxygen, and directing the bubbles in a predetermined direction to lead the wastewater to agitate.

The first blade assembly comprises a plurality of blades fan-shaped and overlapped each other at a predetermined width, each of the fan-shaped blades having a circumference end fixed on an inner circumference of the reaction tank at a predetermined inclined angle and an inner point disposed on a central portion of the reacting tank, the inner points of the blades integrally interconnected, thereby defining bubble passing passage between the adjacent blades.

The bubble passing passage includes an inlet through which the bubbles are introduced from a lower portion of the reacting tank and an outlet through which the bubbles are exhausted to an upper portion of the reaction tank. The blades are assembled such that a bottom central portion has a circular portion having a predetermined area where the fixing shaft is fixed and a top central portion has a point, whereby the area of the inlet is smaller than that of the outlet. Therefore, the bubbles rotates when they passes through the blade assembly because of the area difference.

The dispersion member comprises a fixing shaft extending downward from the blade assembly and a circular plate integrally formed on a lower end of the fixing shaft.

A net is mounted on an exhaust end of the air intake tube to uniformly supply the air into the reacting tank.

The wastewater treatment plant may further comprises agitating means for agitating the wastewater.

As an embodiment, the agitating means comprises a fluid supply tube for communicating an outside of the aeration tank with an inside of the reaction tank, thereby supplying and pouring fluid from the outside of the aeration tank into the inside of the reaction tank.

As another embodiment, the agitating means comprises an agitating blade which is integrally connected to a motor assembly disposed outside the aeration tank.

### BRIEF DESCRIPTION OF DRAWINGS

FIG. 1 is a perspective view of a wastewater treatment plant according to a first preferred embodiment of the present invention;

FIG. 2 is a sectional view of a wastewater treatment plant depicted in FIG. 2;

FIG. 3 is an enlarged perspective view illustrating a top of a first blade assembly depicted in FIG. 1;

FIG. 4 is an enlarge perspective view illustrating a bottom of a first blade assembly depicted in FIG. 1;

FIG. 5 is a sectional view taken along a line A-A of FIG. 2;

FIG. 6 is a plane view of a development figure of a fist blade assembly depicted in FIG. 1; and

FIG. 7 is a perspective view of a wastewater treatment plant according to a second preferred embodiment of the present invention.

### BEST MODE FOR CARRYING OUT THE INVENTION

Preferred embodiments of the present invention will be described more in detail hereinafter with reference to the accompanying drawings.

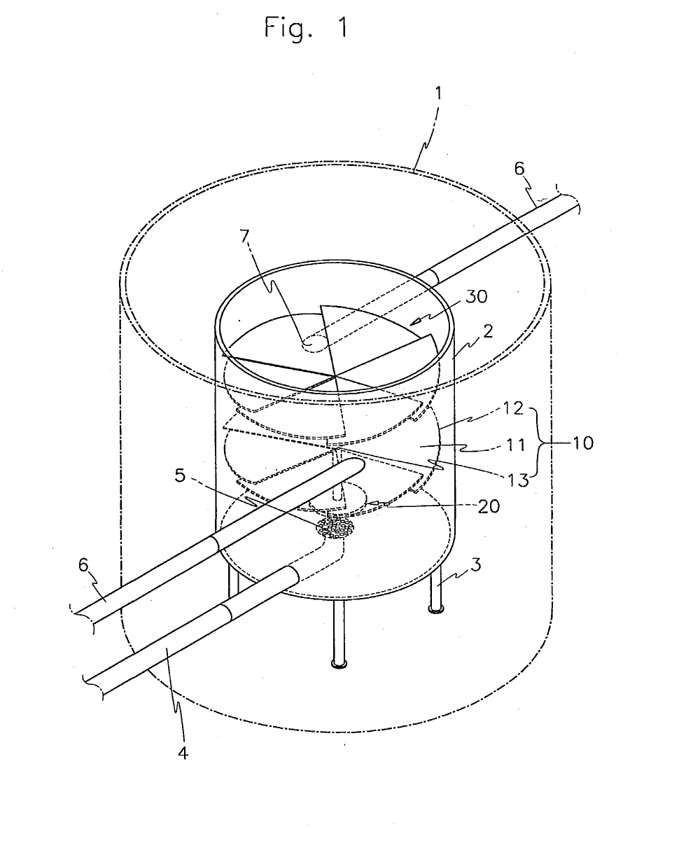

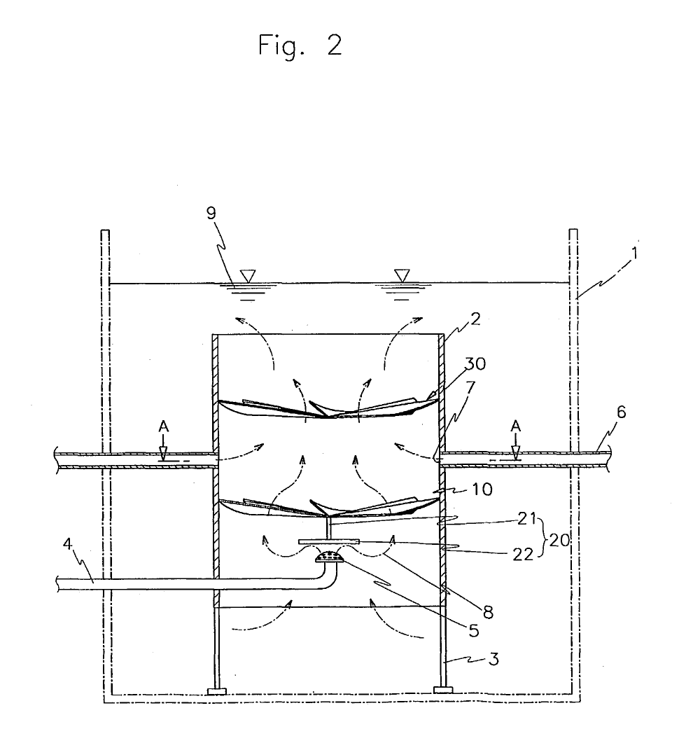

FIG. 1 is a perspective view of a wastewater treatment plant according to a first preferred embodiment of the present invention, and FIG. 2 is a sectional view of a wastewater treatment plant depicted in FIG. 1.

As shown in the drawings, the inventive wastewater treatment plant comprises a cylindrical aeration tank 1 for storing wastewater 9, a reaction tank 2, disposed in the cylindrical aeration tank 1, for purifying the wastewater 1, an air intake tube 4 for inducing air from an outside of the aeration tank 1 into the reaction tank 2, and a dispersion member 20 for creating air bubbles by dispersing the air induced through the air intake tube 4 to the wastewater 9.

Disposed above the dispersion member 20 are a first blade assembly 10 for firstly letting the air bubbles 8 come into collision and prolonging the staying time of the air bubbles 8 to increase the dissolved oxygen. A pair of fluid supply tubes 6 are integrally connected to the sidewall of the reaction tank 2 to direct fluid from the outside of the aeration tank 1 to the inside of the reaction tank 2 to let the wastewater 9 flow in a predetermined direction.

Disposed above the first blade assembly 10 is a second blade assembly 30 for secondly letting the air bubbles 8 come into collision and further prolonging the saying time of the air bubbles 8.

As the reaction tank 2 is cylindrical having opened top and bottom, the wastewater 8 stored in the aeration tank 1 can circulate through the reaction tank 2. The reaction tank 2 is supported by a plurality of legs 3 to maintain its install height.

In addition, the central portions of the dispersion member 20 and the first and second blades assemblies 10 and 20 preferably lies on an central axis of the reaction tank 2, and the air intake tube 4 extends to the central axis under the dispersion member 20 so that the bubbles created in the reaction tank 2 can be uniformly dispersed.

The air intake tube 4 directs air induced by a blower (not shown) to the inside of the reaction tank 2. A net 5 having Φ of about 2-10 mm is mounted on an inner end of the air intake tube 4 to prevent a large amount of air from being abruptly induced in the air intake tube 4.

The dispersion member 20 is integrally mounted on a bottom of a central portion of the first blade assembly 10. Preferably, the dispersion member 20 comprises a circular portion 22 having a diameter of about 100 mm and a fixing shaft 21, having a length less than 50 mm, for connecting the circular plate 22 to the bottom of the central portion of the first blade assembly 10.

Accordingly, the air induced through the air intake tube 4 rises from the inner bottom of the reaction tank 2 to contact a bottom of the circular plate 22 of the dispersion member 20.

The air contacting the circular plate 22 of the dispersion member 20 creates bubbles which further rise to the first blade assembly 10.

The first blade assembly 10 comprises a plurality of blades 11 disposed defining a circular-shape in the reacting tank 2.

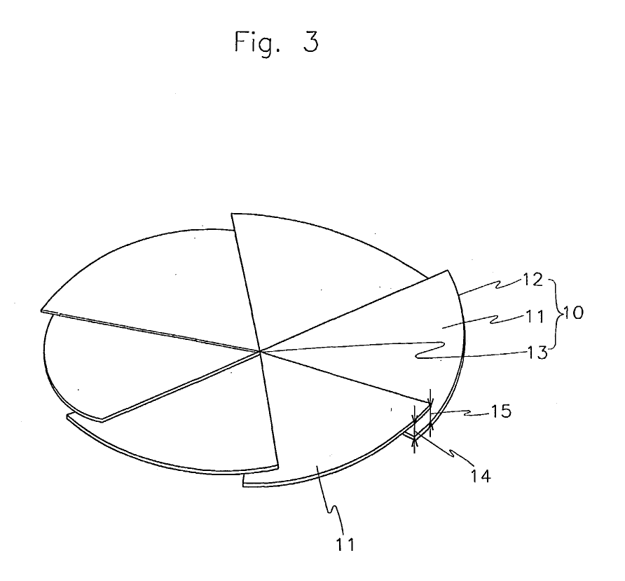

That is, the blades 11 are fan-shaped and overlapped each other at a predetermined width. The first blade assembly 10 will be described more in detail with reference to FIGS. 3, 4 and 5.

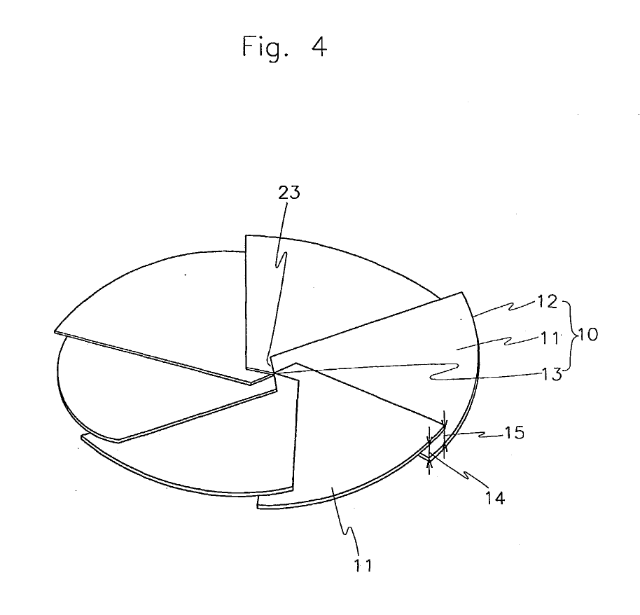

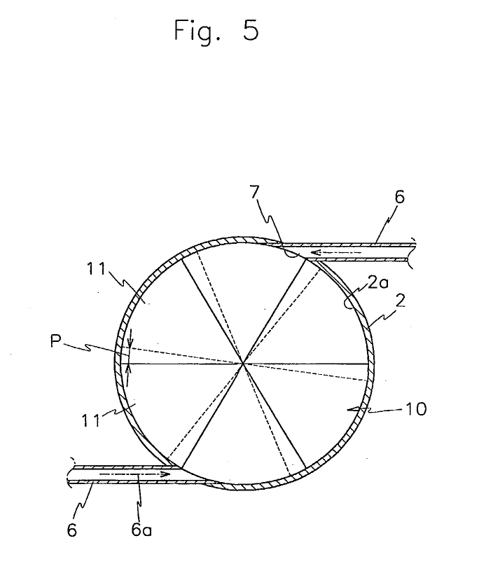

FIGS. 3 and 4 are enlarged views of the top and bottom of the blade assembly, respectively. FIG. 5 is a sectional view taken along a line A-A of FIG. 2.

As shown in the drawings, each of the fan-shaped blades 11 has a circumference end 12 fixed on an inner circumference of the reaction tank 2 and an inner point disposed on a central portion of the reaction tank 2.

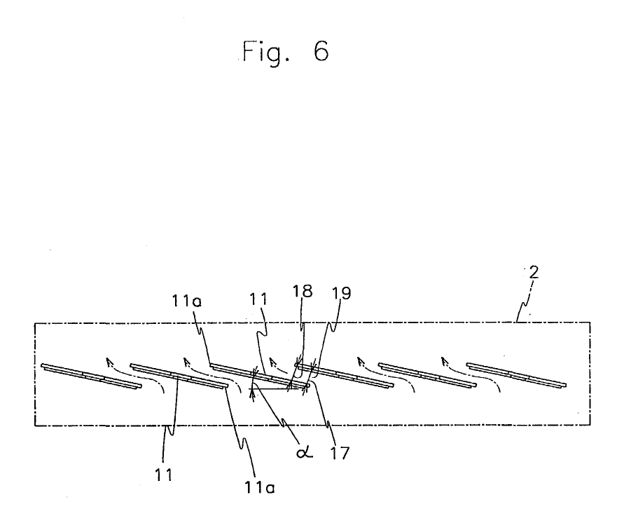

As shown in FIG. 6, each of the blades 11 is inclined in a circumference direction at a predetermined angle of about 10-70 degrees and mounted on the inner circumference wall of the reaction tank 2.

Therefore, the adjacent sides 11a of the adjacent blades 11 are overlapped at a predetermined width, preferably more than 2 cm or ⅓ of an entire area.

As the blades 11 are inclined at the predetermined angle, fluid passages 19 having an inlet 17 and an outlet 18 are defined between the adjacent blades.

Referring to FIG. 2, the bubbles 8 dispersed by the dispersion member 20 pass through the fluid passage 19 via the inlet and outlet 17 and 18 of the first blade assembly 10.

Accordingly, while the bubbles pass through the inlet 17 and outlet 18 of the fluid passage 19, the bubbles 8 collide with each other to create other bubbles. This allows the dissolving time of the bubbles to be prolonged.

The fixing shaft 21 of the dispersion member 20 is fixed on a circular portion 21′ formed on the bottom of the first blade assembly 10. The circular portion 21′ has a predetermined area. Therefore, the bottom area of the blade assembly becomes smaller than the top area of the blade assembly. This means that the inlet area of the blade assembly is smaller than the outlet area of the blade assembly, whereby the bubbles pass through the blade assembly rotates in a predetermined direction by the area difference between the inlet and outlet, increasing the dissolved oxygen.

Referring again to FIGS. 1 and 2, the fluid supply tube 6 is integrally connected on the sidewall of the reaction tank 2 above the first blade assembly 10. The pair of fluid supply tubes 6 communicates the outside of the aeration tank 1 with the inside of the reaction tank 2 through a hole 7 formed on the sidewall of the reaction tank 2.

Accordingly, the fluid 6a (see FIG. 5) is directed into the reaction tank 2 through the pair of fluid supply tubes 6, thereby providing rotational force in the circumference direction to the bubbles 8 passed through the first blade assembly 10 and the wastewater 9. This rotational force provides an agitation effect to the wastewater 9.

The bubbles 8 applied with the rotational force rise and reach the second blade assembly 30. Since the shape of the second blade assembly 30 is identical to that of the first blade assembly 10, the bubbles 8 pass through the second blade assembly 30 as in the first blade assembly 30.

Although two blade assemblies are disclosed in this embodiment, additional blade assembly may be further provided.

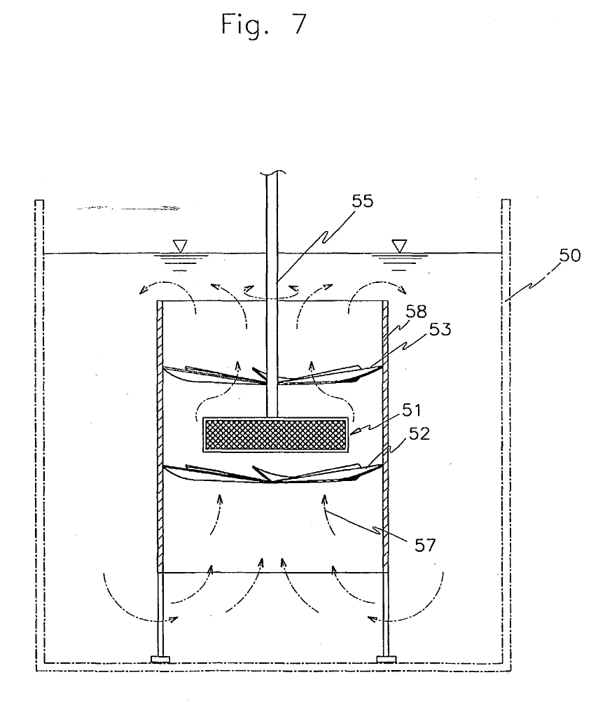

In addition, to agitate the bubbles and the wastewater, as shown in FIG. 7, an agitating blade 51 may be provided instead of the fluid supply tube 6.

That is, the agitating blade 51 is rotatably disposed in an aeration tank 58. That is, the agitating blade 51 is rotatably fixed on a connecting shaft 55 which is designed to rotate by a motor assembly (not shown), thereby rotating the agitating blade 51.

Bubbles 57 passed through a first blade assembly 52 are agitated by the agitating blade 51 and passes the inside of the aeration tank 58.

The wastewater treatment plant provided with the agitating blade 51 is suitably used for a case where the wastewater is agitated only by the agitating blade 51 without supplying the air.

As described above, since the wastewater treatment plant is designed to dissolve gas such as carbon dioxide, ammonia, and the like into the wastewater, the biological treatment may be further enhanced.

The operation of the above described wastewater treatment plant will be described more in detail.

Referring to FIG. 2, air is first introduced from an outside of the aeration tank 1 to the inside of the reaction tank 2 through the air intake tube 4.

The air introduced into the reaction tank 2 creates bubbles 8 from the wastewater. The bubbles 8 rise by potential energy generated by the density difference between the bubbles and the wastewater, and then contact the circular plate 22 of the dispersion member 20 with a predetermined pressure. At this point, the net 5 mounted on the inner end of the air intake tube 4 more effectively disperses the air by controlling an amount of exhaust air.

The bubbles 8 contacting the circular plate 22 of the dispersion member 20 are dispersed in all directions and reach the first blade assembly 10.

The bubbles reached the first blade assembly 10 are introduced into the inlet 17, flows upward along the fluid passage 19, and then are exhausted above the first blade assembly 10 through the outlet 18.

Accordingly, the number of introducing bubbles is greater than that of the exhausting bubbles and the non-surface area is increased, whereby the staying time of the bubbles in the wastewater is prolonged.

In addition, since the blades 11 are inclined in one direction at a predetermined angle ∝, the bubbles 8 passed through the first blade assembly 10 rotate the residual bubbles in a predetermined direction. This provides an agitating effect to the wastewater.

The fluid supply tube 6 connected to the sidewall of the reaction tank 2 pours fluid 6a into the reaction tank 2 with a predetermined pressure. The poured fluid 6a generates a vortex in the reacting tank 2, thereby agitating sludge or wastewater.

A series of tests for purifying tap water using the above described wastewater treatment plant of the present invention and a conventional air dispersion system was conducted.

An identical test conditions such as a test temperature, a volume of the water and an amount of induced air are applied to the wastewater treatment plant of the present invention and the conventional air dispersion system. Na₂ and SO₃ were used to observe the increasing aspect of DO according to the lapse of a predetermined bubbling time from a point where the dissolved oxygen becomes 0.2 mg/L.

The test results are as follows:

(Test Conditions: water temperature—20° C., an amount of used water—1.5 m³, and an amount of induced air—250 l/min)

Test Result Table

| | | Disk-type Air |
|---|---|---|
| | Present Invention | Dispersion System |
| Air Amount (l/min)/Power(W) | 1.3 | 1 |
| Time spent in increasing DO to | 5 | 10 |
| 4 mg/L (min) | | |
| Time spent in increasing DO to | 20 | 30 |
| 8 mg/L (min) | | |

As shown in the table, when the air is dissolved in the wastewater using the wastewater treatment plant according to the present invention, the efficiency of the dissolved oxygen was greatly improved when compared with the conventional disk type air dispersion system.

### Effect of the Invention

The advantages of the wastewater treatment plant according to the present invention are as follows:

First, as oxygen can sufficiently supplied through the air intake tube, a low power system can be used, thereby saving the power costs.

Second, since bubbles supplied to the reaction tank collide with each other while passing through the blade assembly after being risen by the density difference between the bubbles and the wastewater without supplying special energy, the staying time of the bubbles in the wastewater can be prolonged, thereby improving the dissolved oxygen efficiency.

Third, since the fluid is poured into the reaction tank through the fluid supply tube, the wastewater is agitated by the poured fluid and the blade assembly can provide an agitating effect to the wastewater, the agitating efficiency can be improved for considering the consumed power.

Fourth, since the structure of the air intake tube for introducing air into the reaction tank is simple, it can be prevented that the air intake tube is blocked.

Fifth, since the fluid poured from the fluid supply tube allows for the agitation of the wastewater, the system functions as an agitating system as well as a dissolving system.

While this invention has been described in connection with what is presently considered to be the most practical and preferred embodiments, it is to be understood that the invention is not limited to the disclosed embodiments, but, on the contrary, is intended to cover various modifications and equivalent arrangements included within the spirit and scope of the appended claims.

1. A wastewater treatment plant comprising:
an aeration tank for storing wastewater;
a reaction tank disposed inside the aeration tank, the wastewater being purified while circulating inside the reaction tank and being supplied with oxygen;
an air intake tube for introducing air into the reaction tank;
a dispersion member for dispersing the air introduced through the air intake tube to the wastewater to generate bubbles; and
a blade assembly disposed inside the reaction tank for having the bubbles dispersed by the dispersion member come into collision with each other, prolonging a staying time of the bubbles to increase the dissolved oxygen, and directing the bubbles in a predetermined direction to lead the wastewater to agitate.

2. A wastewater treatment plant of claim 1 wherein the first blade assembly comprises a plurality of blades fan-shaped and overlapped each other at a predetermined width, each of the fan-shaped blades having a circumference end fixed on an inner circumference of the reaction tank at a predetermined inclined angle and an inner point disposed on a central portion of the reacting tank, the inner points of the blades integrally interconnected, thereby defining bubble passing passage between the adjacent blades.

3. A wastewater treatment plant of claim 2 wherein the bubble passing passage includes an inlet through which the bubbles are introduced from a lower portion of the reacting tank and an outlet through which the bubbles are exhausted to an upper portion of the reaction tank, the blade assembly being provided at its bottom with a circular portion having a predetermined area where a fixing shaft for supporting the dispersion member so that the bottom area of the blade assembly becomes smaller that the top area of the blade assembly, making the bubbles pasting therethrough rotates.

4. A wastewater treatment plant of claim 1 wherein the dispersion member comprises a fixing shaft extending downward from the blade assembly and a circular plate integrally formed on a lower end of the fixing shaft.

5. A wastewater treatment plant of claim 1 wherein a net is mounted on an exhaust end of the air intake tube to uniformly supply the air into the reacting tank.

6. A wastewater treatment plant of claim 1 further comprising agitating means for agitating the wastewater.

7. A wastewater treatment plant of claim 6 wherein the agitating means comprises a fluid supply tube for communicating an outside of the aeration tank with an inside of the reaction tank, thereby supplying and pouring fluid from the outside of the aeration tank into the inside of the reaction tank.

8. A wastewater treatment plant of claim 6 wherein the agitating means comprises an agitating blade which is integrally connected to a motor assembly disposed outside the aeration tank.
